(19) United States
(12) Patent Application Publication
(10) Pub. No.: US 2008/0170088 A1
(43) Pub. Date: Jul. 17, 2008

(54) Ejection of drops having variable drop size from an ink jet printer

(76) Inventors: William Letendre, Etna, NH (US); Robert Hasenbein, Enfield, NH (US); Deane A. Gardner, Cupertino, CA (US)

Correspondence Address: FISH & RICHARDSON PC, P.O. BOX 1022, MINNEAPOLIS, MN, 55440-1022, US

(21) Appl. No.: 11/652,325

(22) Filed: Jan. 11, 2007

(51) Int. Cl. B41J 29/38; B41J 2/045

(52) U.S. Cl. 347/6; 347/68

(57) ABSTRACT

A method for causing ink to be ejected from an ink chamber of an ink jet printer includes causing a first bolus of ink to be extruded from the ink chamber; and following lapse of a selected interval, causing a second bolus of ink to be extruded from the ink chamber. The interval is selected to be greater than the reciprocal of the fundamental resonant frequency of the chamber, and such that the first bolus remains in contact with ink in the ink chamber at the time that the second bolus is extruded.

### FIELD OF INVENTION

This invention relates to ink-jet printers, and in particular, to ink-jet printers capable of ejecting drops having variable drop sizes.

### BACKGROUND

In a piezoelectric ink jet printer, a print head includes a large number of ink chambers, each of which is in fluid communication with an orifice and with an ink reservoir. At least one wall of the ink chamber is coupled to a piezoelectric material. When actuated, the piezoelectric material deforms. This deformation results in a deformation of the wall, which in turn launches a pressure wave that ultimately pushes ink out of the orifice while drawing in additional ink from an ink reservoir.

To provide greater density variations on a printed image, it is often useful to eject ink droplets of different sizes from the ink chambers. One way to do so is to sequentially actuate the piezoelectric material. Each actuation of the piezoelectric material causes a bolus of ink to be pumped out the orifice. If the actuations occur at a frequency that is higher than the resonant frequency of the ink chamber, successive boluses will arrive at the orifice plate before the first bolus has begun its flight to the substrate. As a result, all of the boluses merge together into one droplet. The size of this one droplet depends on the number of times actuation occurs before the droplet begins its flight from the orifice to the substrate. An ink jet printer of this type is disclosed in co-pending application Ser. No. 10/800,467, filed on Mar. 15, 2004, the contents of which are herein incorporated by reference.

### SUMMARY

In one aspect, the invention features a method for causing ink to be ejected from an ink chamber of an ink jet printer. Such a method includes causing a first bolus of ink to be extruded from the ink chamber; and following lapse of a selected interval, causing a second bolus of ink to be extruded from the ink chamber. The interval is selected to be greater than the reciprocal of the fundamental resonant frequency of the chamber, and such that the first bolus remains in contact with ink in the ink chamber at the time that the second bolus is extruded.

Some practices include causing the second bolus to be ejected includes imparting, to the second bolus, a velocity in excess of a velocity of the first bolus.

Other practices include, following lapse of the selected interval, causing a third bolus of ink to be extruded from the ink chamber. In some of these practices, causing a third bolus of ink to be extruded includes imparting, to the third bolus, a velocity in excess of a velocity of the second bolus. Among these practices are those that also include causing the first, second, and third boluses to have respective first, second, and third momentums selected such that a drop lifetime of an ink-drop containing the first, second, and third boluses is equal to a drop lifetime of an ink-drop formed from two boluses of ink.

Other practices include those in which the interval is selected to be between about 15 microseconds and 16 microseconds.

Yet other practices include causing the first and second boluses to have first and second momentums selected such that a drop lifetime of an ink drop that contains the first and second boluses is equal to a drop lifetime of an ink drop formed from a single bolus of ink.

Additional practices include those in which causing first and second boluses of ink to be extruded includes selecting a combination of ejection pulses from a palette of pre-defined ejection pulses.

The invention also features, in another aspect, a method for ejecting ink from an ink chamber of an ink jet printer head. Such a method includes determining a first number of ink boluses needed to generate an ink drop having a selected drop size; extruding ink to form a free-surface fluid guide having a length that increases with time and extending between ink in the ink chamber and a leading ink bolus moving away from the orifice, and causing a set of follower ink boluses to travel along the free-surface fluid guide toward this leading bolus. The number of boluses in this set of follower boluses is one less than the first number. These boluses are temporally separated by an interval greater than the reciprocal of the fundamental resonant frequency of the ink chamber.

In some practices, causing a set of follower ink boluses to travel along the free-surface fluid guide includes causing the follower boluses to travel at velocities greater than a velocity of the leading bolus.

Other aspects of the invention include machine-readable media having encoded thereon software for causing execution of any of the foregoing methods.

In another aspect, the invention features a piezoelectric print head for an ink jet printer. Such a print head includes walls defining an ink chamber; a piezoelectric actuator in mechanical communication with the ink chamber; and a controller for controlling the piezoelectric actuator. The controller is configured to cause the piezoelectric actuator to cause extrusion of a first bolus of ink from the ink chamber, and following lapse of a selected interval, extrusion of a second bolus of ink from the ink chamber. The interval is selected to be greater than the reciprocal of the fundamental resonant frequency of the chamber. In addition, the interval is selected such that the first bolus remains in contact with ink in the ink chamber at the time that the second bolus is extruded.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE FIGURES

FIG. 1 shows an ink chamber from an ink jet print head;

FIG. 2 shows an ejection pulse;

FIG. 3 shows a palette having three ejection pulses;

FIG. 4 shows independent ink droplets on their way to a substrate

FIG. 5 shows a single large ink drop on its way to the substrate;

FIG. 6 shows boluses of ink that combine to form an ink drop;

FIG. 7 shows boluses of ink produced by the excitation waveform of FIG. 3; and

FIG. 8 illustrates drop lifetime and pulse delay.

### DETAILED DESCRIPTION

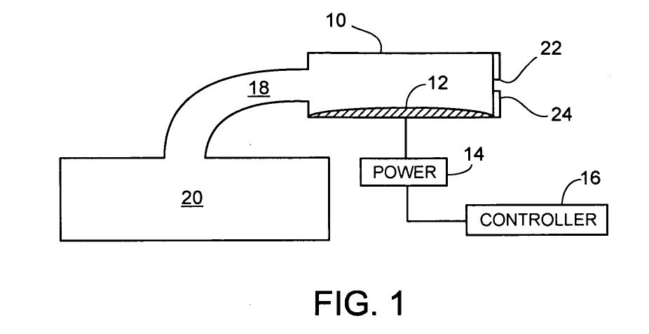

FIG. 1 shows an ink chamber 10 associated with one of many ink jets in a piezoelectric print head of an ink jet printer. The ink chamber 10 has an active wall 12 coupled to a piezoelectric material that is connected to a power source 14 under the control of a controller 16. A passageway 18 at one end of the ink chamber 10 provides fluid communication with an ink reservoir 20 shared by many other ink chambers (not shown) of the print head. At the other end of the ink chamber 10, an orifice 22 formed by an orifice plate 24 provides fluid communication with the air external to the ink chamber 10.

In operation, the controller 16 receives instructions indicative of a size of a drop to be ejected. On the basis of the desired size, the controller 16 applies an excitation waveform to the active wall 12.

The excitation waveform includes a selection of one or more ejection pulses from a palette of pre-defined ejection pulses. Each ejection pulse extrudes a bolus of ink through the orifice 22. The number of ejection pulses selected from the palette and assembled into a particular excitation waveform depends on the size of the desired drop. In general, the larger the drop sought, the greater the number of boluses needed to form it, and hence, the more ejection pulses the excitation waveform will contain.

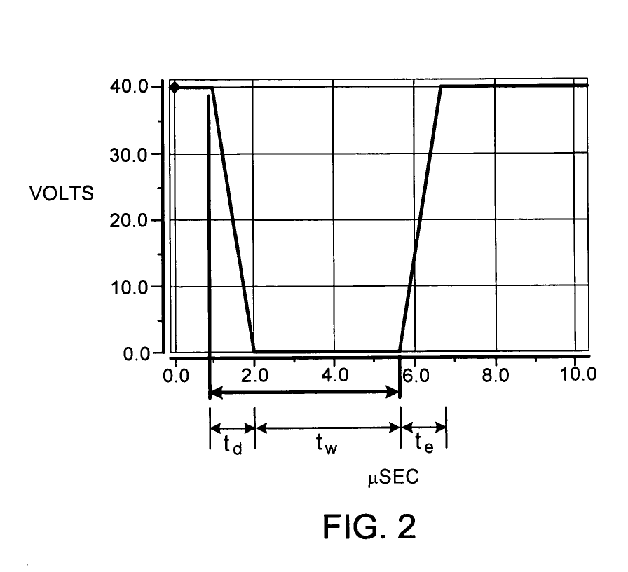

FIG. 2 shows one such pre-defined ejection pulse from a palette of ejection pulses. The ejection pulse begins with a draw phase in which the piezoelectric material is deformed so as to cause the ink chamber 10 to enlarge in volume. This causes ink to be drawn from the reservoir 20 and into the ink chamber 10.

The deformation that occurs during the draw phase results in a first pressure wave that originates at the source of the disturbance, namely the active wall 12. This first pressure wave travels away from the its source in both directions until it reaches a point at which it experiences a change in acoustic impedance. At that point, at least a portion of the energy in the first pressure wave is reflected back toward the source.

Following the lapse of a draw time t_{d}, a waiting phase begins. The duration of the waiting phase, referred to as the “wait time t_{w}”, is selected to allow the above-mentioned pressure wave to propagate outward from the source, to be reflected at the point of impedance discontinuity, and to return to its starting point. This duration thus depends on velocity of wave propagation within the ink chamber 10 and on the distance between the source of the wave and the point of impedance discontinuity.

Following the waiting phase, the controller 16 begins an ejection phase having a duration defined by an ejection time tₑ. In the ejection phase, the piezoelectric material deforms so as to restore the ink chamber 10 to its original volume. This initiates a second pressure wave. By correctly setting the duration of the waiting phase, the first and second pressure waves can be placed in phase and therefore be made to add constructively. The combined first and second pressure waves thus synergistically extrude a bolus of ink through the orifice 22.

The extent to which the piezoelectric material is deformed during the draw phase governs the momentum associated with the bolus formed as a result of the ejection pulse.

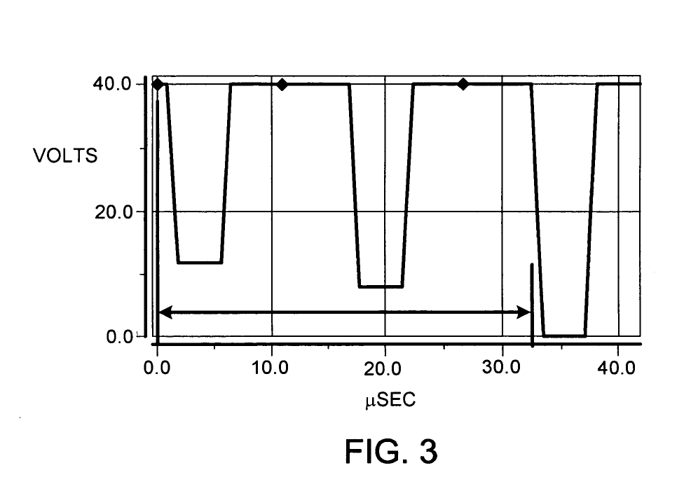

FIG. 3 shows an ejection pulse palette having three ejection pulses. Each ejection pulse is characterized by, among other attributes, a pulse amplitude and a pulse delay. The pulse amplitude controls the momentum of a bolus formed by the ejection pulse. The pulse delay of an ejection pulse is the time interval between a reference time and a particular event associated with the ejection pulse. A useful choice for a reference time is the time at which the printer control circuitry sends a trigger pulse. This time can be viewed as the start of an excitation waveform. A useful choice for an event to mark the other end of the pulse delay is the start of the ejection pulse.

FIG. 3 can also be viewed as an excitation waveform that uses all three ejection pulses available in an excitation palette. Other excitation waveforms would include subsets of the three available ejection pulses. For example, a two-bolus ink drop would be formed by an excitation waveform having only the first and third ejection pulses, only the first and second ejection pulses, or only the second and third ejection pulses. A one-bolus ink drop would be formed by an excitation waveform having only one of the three available ejection pulses.

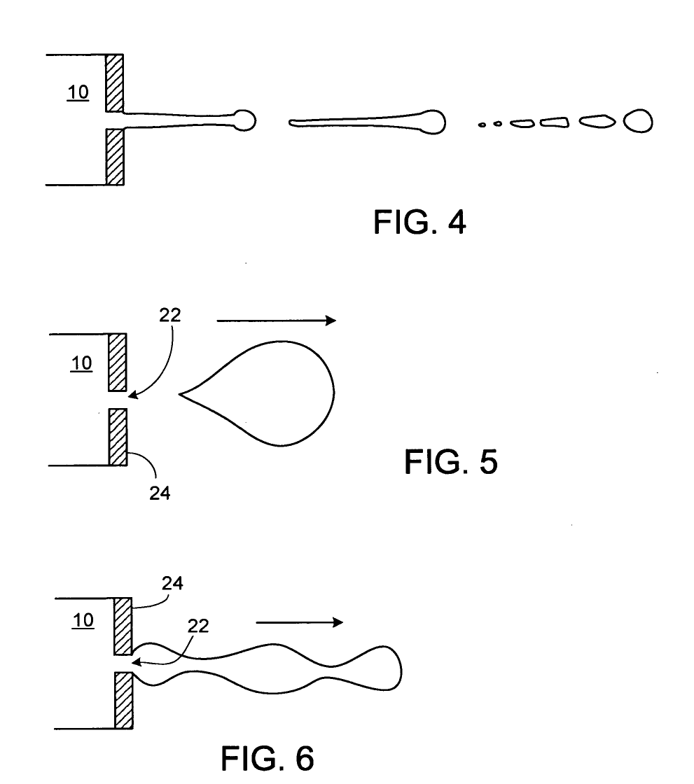

In a first mode of operation, the intervals between the consecutive pulses are relatively long. When operated in this manner, the bolus extruded by the first pulse begins its flight from the orifice plate 24 to the substrate before extrusion of the second bolus. This first mode of operation thus leads to a series of independent droplets flying toward the substrate as shown in FIG. 4. These droplets combine with each other, either in flight or at the substrate, to form a larger drop.

The long tails connected to the droplets shown in FIG. 4 break up into satellites during their flight. These tails may then land on the substrate in an uncontrolled way. Uncontrolled distribution of ink from these tails thus causes stray marks on the substrate, and thereby undermines print quality.

In a second mode of operation, the intervals between ejection pulses are very short. When operated in this rapid-fire manner, the boluses are extruded so rapidly that they combine with each other while still attached to ink on the orifice plate 24. This results in the formation of a single large drop, as shown in FIG. 5, which then leaves the orifice plate 24 fully formed. This second mode of operation avoids the formation of a great many tails.

In a third mode of operation, the intervals between the ejection pulses are chosen to be long enough to avoid rectified diffusion, but short enough so that the boluses extruded by the sequence of pulses remain connected to each other by ligaments as they leave the orifice plate 24 on their way to the substrate. An exemplary string of such boluses is shown in FIG. 6.

In this third mode of operation, the surface tension associated with the inter-bolus ligaments tends to draw the boluses together into a single drop. This avoids the formation of many long tails that may spatter uncontrollably onto the substrate.

The exact numerical parameters associated with the ejection pulses depends on the details of the particular ink chamber 10 and on the properties of the ink. However, as a general rule, the time interval between ejection pulses corresponds to a frequency that is lower than the fundamental resonant frequency of the ink chamber 10, but not so low that the boluses separate from each other and form discrete droplets, as shown in FIG. 4. This time interval between ejection pulses is thus greater than the reciprocal of the fundamental (i.e. lowest) resonant frequency expressed in cycles per second.

For the case of an ink having a viscosity of 11 cps at 40° C., FIG. 3 is an exemplary excitation waveform for forming drops having a mass as high as 20 ng and doing so at a rate sufficient to eject such a drop every 50 microseconds (i.e. at a drop ejection frequency of 20 kHz). The ejection pulses are separated from each other by approximately 15-16 microseconds (i.e., at a pulse repetition frequency of 63.5 kHz).

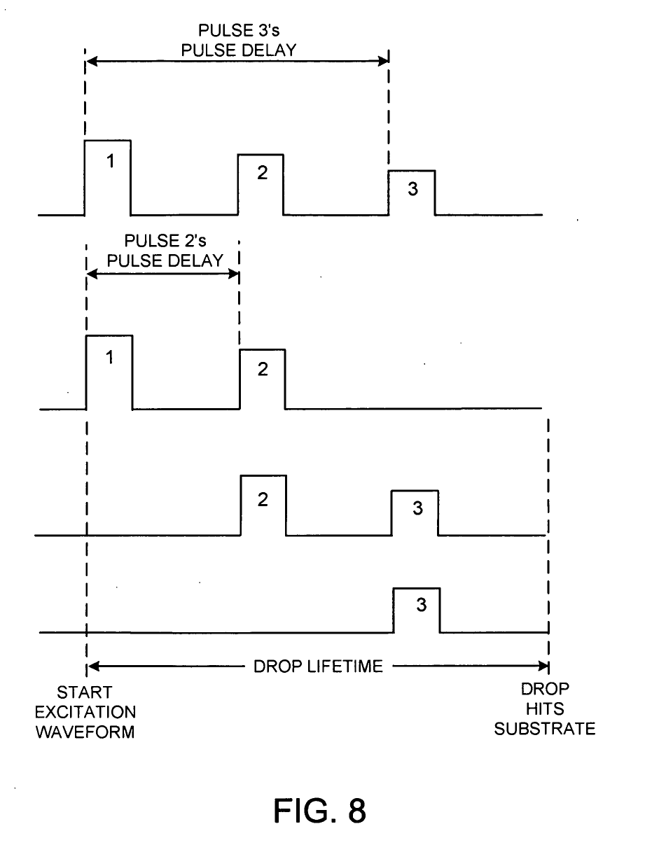

The amplitudes and pulse delays of the ejection pulses available for assembling the excitation waveform are selected so that the interval between the start of the excitation waveform and the time the ink drop formed by that waveform hits the substrate (referred to herein as the “drop lifetime”) is independent of the size of the ink drop. As used herein, and as illustrated in FIG. 8, the start of the excitation waveform need not coincide with the start of the first ejection pulse used in that waveform. For example, if the excitation waveform for a particular drop uses only the second of the three available ejection pulses, then the start of the excitation waveform is considered to be the time at which the first ejection pulse would have begun had the first ejection pulse been used. The judicious selection of ejection pulse amplitudes and delays in this way means that the time at which the print-head driving circuit sends a trigger signal is independent of the drop size. Rather, what changes as a function of drop size is the selection, from the palette of ejection pulses, of those ejection pulses that constitute the particular excitation waveform for that ink drop. This greatly simplifies the design of the drive circuit.

Although FIG. 8 shows upwardly extending pulses, this is not meant to imply anything about the actual signs of voltages and currents used in the driving circuitry. It is to ensure this generality that the vertical axis of FIG. 8 omits any reference to polarity.

In the particular palette of ejection pulses shown in FIG. 3, the voltage drop increases with pulse delay. As a result, the first bolus formed has the lowest momentum and the subsequent boluses have successively higher momentums. This allows the later formed boluses to more easily catch up with the earlier formed boluses.

While the palette of ejection pulses shown in FIG. 3 has only three ejection pulses, the principles described herein can readily be applied to excitation waveforms that have any number of ejection pulses.

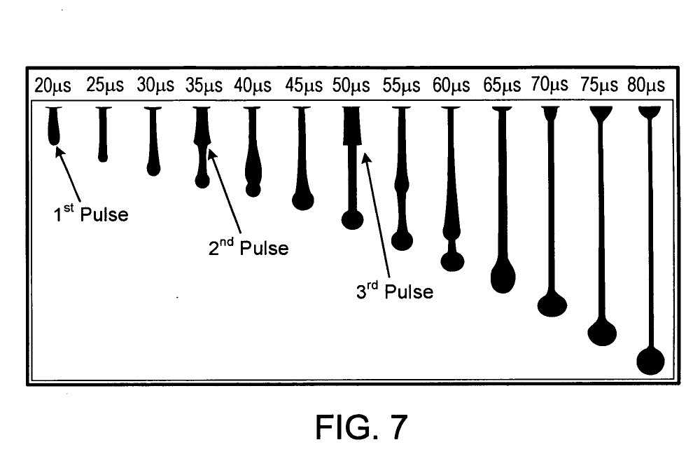

FIG. 7 shows photographs taken every 5 microseconds and placed side-by-side to show three boluses combining to form a single drop. By the 30 microsecond mark, a slow-moving first bolus threatens to disconnect itself from the orifice plate and begin its flight to the substrate. The first bolus, however, continues to be in contact with ink within the ink chamber 10 through a ligament.

Then, at 35 microseconds, while the first bolus is still in contact with ink within the ink chamber 10, a faster moving second bolus begins to catch up to the first bolus. In doing so, the second bolus travels along the ligament that connects the first bolus to the ink in the ink chamber 10.

At 40 microseconds, the first and second boluses begin to merge, and by 45 microseconds, the drop has grown by the mass of the second bolus. Meanwhile, the ligament continues to stretch.

By 50 microseconds, a fast-moving third bolus has emerged from the orifice and rapidly moves up the ligament to join the drop formed by the first and second boluses. Within the next 15 microseconds, the third bolus catches up with the drop and merges into it. Then, over the next ten microseconds, the drop, which now has the accumulated mass of three boluses, finally breaks free of the orifice plate and begins its flight to the substrate.

Excitation waveforms for forming smaller drops will extrude fewer boluses. As a result, such excitation waveforms will be like that shown in FIG. 3 but with fewer ejection pulses. For example, one can generate a small ink drop by selecting only one of the pre-defined ejection pulses from FIG. 3, or one can generate a slightly larger ink drop by selecting two of the three pre-defined ejection pulses shown in FIG. 3. In one practice, the second ejection pulse of FIG. 3 by itself to creates a one-bolus ink drop, the first and third ejection pulses of FIG. 3 cooperate to create a two-bolus ink drop, and all three ejection pulses shown in FIG. 3 cooperate to create a three-bolus ink drop. However, depending on the specific combination of pulse delays and amplitudes that are available in a palette of ejection pulses, different combinations of ejection pulses can be chosen. For example, in some cases, the first or third ejection pulses can be used to create a one-bolus drop. In other cases, either the first and second pulses or the second and third pulses can cooperate to create a two-bolus ink drop.

In some printers, four or more ink drop sizes may be available, in which case the palette of ejection pulses will have four or more available ejection pulses.

In general, the ensemble of ejection pulses available for assembly into an excitation waveform includes ejection pulses having amplitudes and delays selected to maximize the number of different ink-drop sizes that can be created, subject to the constraint that the drop lifetime be independent of the drop size. In some cases, this includes providing a large drop with sufficient momentum so that the velocity of the large drop is the same as that of a smaller drop. Or, if the large and small drops have velocities that differ, one can choose ejection pulses with longer delays for the faster moving drop, thereby giving the slower-moving drop a head start. In such cases, the faster-moving drop and the slower-moving drop would arrive at the substrate at the same time.

In the case of multi-bolus ink drops, the ink mass associated with the tail is capped by the ink-mass of the bolus formed by the last of the ejection pulses. As a result, the mass of the tail is not proportional to the mass of the ink drop. Instead, as the ink drop becomes larger, the ratio of the tail's mass to that of the ink drop becomes progressively smaller.

In the drop formation process shown in FIG. 7, the ligament effectively forms a dynamically lengthening free-surface fluid guide, or transmission line, for the propagation of pressure pulses from the ink chamber 10 to the first bolus. These pressure pulses cause additional boluses to travel up the transmission line toward the first bolus.

The fluid guide is a “free-surface” fluid guide because the surface of the fluid guide is also the surface of the fluid. The fluid guide is thus held together by the surface tension of the ink that forms the ligament. As a result, the greater the ink's surface tension, the longer the fluid guide can be maintained, and the more time there will be for successive boluses to travel down the guide to merge with the leading bolus.

Having described the invention, and a preferred embodiment thereof, what is claimed as new, and secured by Letters Patent is:

1. A method for causing ink to be ejected from an ink chamber of an ink jet printer, the method comprising:
causing a first bolus of ink to be extruded from the ink chamber;
following lapse of a selected interval, causing a second bolus of ink to be extruded from the ink chamber;
wherein the interval is selected to be greater than the reciprocal of the fundamental resonant frequency of the chamber, and
wherein the interval is selected such that the first bolus remains in contact with ink in the ink chamber at the time that the second bolus is extruded.

2. The method of claim 1, wherein causing the second bolus to be ejected comprises imparting, to the second bolus, a velocity in excess of a velocity of the first bolus.

3. The method of claim 1, further comprising, following lapse of the selected interval, causing a third bolus of ink to be extruded from the ink chamber.

4. The method of claim 3, wherein causing a third bolus of ink to be extruded comprises imparting, to the third bolus, a velocity in excess of a velocity of the second bolus.

5. The method of claim 1, further comprising selecting the interval to be between about 15 microseconds and 16 microseconds.

6. The method of claim 1, further comprising causing the first and second boluses to have first and second momentums selected such that a drop lifetime of an ink drop that contains the first and second boluses is equal to a drop lifetime of an ink drop formed from a single bolus of ink.

7. The method of claim 1, wherein causing first and second boluses of ink to be extruded comprises selecting a combination of ejection pulses from a palette of pre-defined ejection pulses.

8. The method of claim 4, further comprising causing the first, second, and third boluses to have respective first, second, and third momentums selected such that a drop lifetime of an ink-drop containing the first, second, and third boluses is equal to a drop lifetime of an ink-drop formed from two boluses of ink.

9. A method for ejecting ink from an ink chamber of an ink jet printer head, the method comprising:
determining a first number of boluses of ink required to generate an ink drop having a selected drop size;
extruding ink to form a free-surface fluid guide having a length that increases with time, the free-surface fluid guide extending between ink in the ink chamber and a leading bolus of ink moving away from the orifice;
causing a set of follower ink boluses to travel along the free-surface fluid guide toward the leading bolus, the set of follower boluses having a number of boluses that is one less than the first number, the boluses being temporally separated by an interval greater than the reciprocal of the fundamental resonant frequency of the ink chamber.

10. The method of claim 9, wherein causing a set of follower ink boluses to travel along the free-surface fluid guide comprises causing the follower boluses to travel at velocities greater than a velocity of the leading bolus.

11. A machine-readable medium having encoded thereon software for causing ink to be ejected from an ink chamber of an ink jet printer, the software comprising instructions for:
causing a first bolus of ink to be extruded from the ink chamber;
following lapse of a selected interval, causing a second bolus of ink to be extruded from the ink chamber;
wherein the interval is selected to be greater than the reciprocal of the fundamental resonant frequency of the chamber, and wherein the interval is selected such that the first bolus remains in contact with ink in the ink chamber at the time that the second bolus is extruded.

12. The machine-readable medium of claim 11, wherein the instructions for causing the second bolus to be ejected comprise instructions for imparting, to the second bolus, a velocity in excess of a velocity of the first bolus.

13. The machine-readable medium of claim 11, wherein the software further comprises instructions for, following lapse of the selected interval, causing a third bolus of ink to be extruded from the ink chamber.

14. The machine-readable medium of claim 13, wherein the instructions for causing a third bolus of ink to be extruded comprise instructions for imparting, to the third bolus, a velocity in excess of a velocity of the second bolus.

15. The machine-readable medium of claim 11, wherein the software further comprises instructions for selecting the interval to be between about 15 microseconds and 16 microseconds.

16. The machine-readable medium of claim 11, wherein the software further comprises instructions for causing the first and second boluses to have first and second momentums selected such that a drop lifetime of an ink drop that contains the first and second boluses is equal to a drop lifetime of an ink drop formed from a single bolus of ink.

17. The machine-readable medium of claim 11, wherein the instructions for causing first and second boluses of ink to be extruded comprise instructions for selecting a combination of ejection pulses from a palette of pre-defined ejection pulses.

18. The machine-readable medium of claim 14, wherein the software further comprises instructions for causing the first, second, and third boluses to have respective first, second, and third momentums selected such that a drop lifetime of an ink-drop containing the first, second, and third boluses is equal to a drop lifetime of an ink-drop formed from two boluses of ink.

19. A machine-readable medium having encoded thereon software for ejecting ink from an ink chamber of an ink jet printer head, the software comprising instructions for:
determining a first number of boluses of ink required to generate an ink drop having a selected drop size;
extruding ink to form a free-surface fluid guide having a length that increases with time, the free-surface fluid guide extending between ink in the ink chamber and a leading bolus of ink moving away from the orifice;
causing a set of follower ink boluses to travel along the free-surface fluid guide toward the leading bolus, the set of follower boluses having a number of boluses that is one less than the first number, the boluses being temporally separated by an interval greater than the reciprocal of the fundamental resonant frequency of the ink chamber.

20. The machine-readable medium of claim 19, wherein the instructions for causing a set of follower ink boluses to travel along the free-surface fluid guide comprise instructions for causing the follower boluses to travel at velocities greater than a velocity of the leading bolus.

21. A piezoelectric print head for an ink jet printer, the print head comprising:
walls defining an ink chamber;
a piezoelectric actuator in mechanical communication with the ink chamber;
a controller for controlling the piezoelectric actuator, the controller being configured to cause the piezoelectric actuator to cause
extrusion of a first bolus of ink from the ink chamber, and following lapse of a selected interval,
extrusion of a second bolus of ink from the ink chamber,
wherein the interval is selected to be greater than the reciprocal of the fundamental resonant frequency of the chamber, and
wherein the interval is selected such that the first bolus remains in contact with ink in the ink chamber at the time that the second bolus is extruded.
